(19) United States
(12) Patent Application Publication
(10) Pub. No.: US 2010/0011358 A1
(43) Pub. Date: Jan. 14, 2010

(54) Virtualization Based Personalizable Consumer Electronics Platform

(76) Inventors: Kevin A. Kettler, Austin, TX (US); Shree A. Dandekar, Round Rock, TX (US)

Correspondence Address: HAMILTON & TERRILE, LLP, P.O. BOX 203518, AUSTIN, TX, 78720, US

(21) Appl. No.: 12/172,544

(22) Filed: Jul. 14, 2008

(51) Int. Cl. G06F 9/455; H04L 9/32

(52) U.S. Cl. 718/1; 713/156

(57) ABSTRACT

A simple to customize IT infrastructure architecture. The IT infrastructure architecture includes a general-purpose virtualized architecture platform. The IT infrastructure architecture is well suited for delivering simple pre-packaged software solutions to the small business segment as plug and play type appliances. In certain preferred embodiments, the IT infrastructure architecture includes a virtual appliance memory device such as a virtual appliance universal serial bus (USB) key. The IT infrastructure architecture uses embedded server virtualization technology to host business applications as a virtual appliance.

### CROSS REFERENCE TO RELATED APPLICATIONS

This application relates to application Ser. No. ______ (Attorney Docket Number DC-14303), filed herewith, entitled “Modular Virtual Machine Server” and naming Gary Huber, Kevin Kettler, Yuan-Chang Lo, William Dale Todd Nix, as inventors, the application being incorporated herein by reference in its entirety.

### BACKGROUND OF THE INVENTION

1. Field of the Invention

The present invention relates to information handling systems and more particularly to virtualization based personalizable consumer electronics platform.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Consumer electronics devices continue to mature to include consumer electronics type information handling systems. Consumer electronics type information handling systems enable content migration from a media information handling system to a living room as well as enabling televisions for broadband. One example of such a consumer electronics type information handling system includes a direct memory access (DMA) functionality using software such as the Microsoft extender technology software. Such a system provides no control over a software architecture to enable future services and provides no manufacturer differentiation.

Other issues relating to consumer electronics type information handling systems include limited adoption due to high set up costs and customer awareness. Often known solution slack flexibility in terms of controlling software ad hardware distribution. Often known solutions do not offer personalization.

Attempting to address these issues via known information handling system platforms can also present challenges. For example, known information handling system platforms generally use well-defined development evolution based upon standard architectures. Also within known information handling system platforms, extensibility for added features is usually enabled using add in network interface controllers and controllers within predefined expansion slots such as PCIe slots. Other expansion may be accomplished via embedded controller for storage and multimedia playback devices. Such platforms have often include well defined end user models for Internet access, email and office type applications as well as the inability to provide a customer with a secure environment to plug in certain desired services or applications.

Accordingly, it would be desirable to provide an easily manageable and expandable array of consumer electronics based functions to consumers with limited or no information technology (IT) capabilities.

### SUMMARY OF THE INVENTION

In accordance with the present invention, a simple to customize consumer electronics type information handling system infrastructure architecture is provided. The consumer electronics type information handling system infrastructure architecture includes a general purpose virtualized x86 architecture platform. The consumer electronics type information handling system infrastructure architecture is well suited for delivering simple pre-packaged software solutions to a consumer segment as plug and play type appliances. In certain preferred embodiments, the consumer electronics type information handling system infrastructure architecture includes a virtual appliance memory device such as a virtual appliance universal serial bus (USB) key. The consumer electronics type information handling system infrastructure architecture uses virtualization technology to host consumer applications as a virtual appliance.

Thus, the consumer electronics type information handling system provides a hybrid architecture to enable an end user to build extensibility features and applications using virtualized modules coupled to a central kernel hardware architecture model based on a known hardware architecture such as the X86 hardware architecture. Such a system provides a stable platform with no variability from one user to another. Additionally, such a system provides for an easy plug and play of services and the flexibility to port an appliance from one system to another such as providing an easy method for moving games or movies from one system to another. Additionally, such a system provide for an easily configured media server, and content delivery platform.

In one embodiment, the invention relates to a method for delivering pre-packaged software solutions to a consumer electronics type information handling system that includes providing a virtual machine (VM) host comprising a plurality of VM resources operable to execute virtual machines, providing a virtual appliance memory device where the virtual appliance memory device includes a virtual appliance that comprises an application stored on the virtual appliance memory device, installing the virtual appliance onto the virtual machine host via the virtual appliance memory device, and hosting the application via the virtual appliance.

In another embodiment, the invention relates to an apparatus for delivering pre-packaged software solutions to a consumer electronics type information handling system that includes a virtual machine (VM) host comprising a plurality of VM resources operable to execute virtual machines, a virtual appliance memory device that includes a virtual appliance comprising an application stored on the virtual appliance memory device, means for installing the virtual appliance onto the virtual machine host via the virtual appliance memory device, and means for hosting the application via the virtual appliance.

In another embodiment, the invention relates to a consumer electronics type information handling system that includes a virtual appliance memory device for delivering pre-packaged software solutions to the information handling system where the virtual appliance memory device includes a virtual appliance comprising an application stored on the virtual appliance memory device, a virtual machine (VM) host comprising a plurality of VM resources operable to execute virtual machines wherein the virtual machine host installs the virtual appliance onto the virtual machine host via the virtual appliance memory device and hosts the application via the virtual appliance.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1 shows a system block diagram of an information handling system.

FIG. 2 shows a system block diagram of a consumer electronics type information handling system infrastructure architecture.

FIG. 3 shows a flow chart of the operation of a consumer electronics type information handling system infrastructure architecture.

FIG. 4 shows a flow chart of the operation of a consumer electronics type information handling system infrastructure architecture.

FIG. 5 shows a conceptual perspective view of a panel of a consumer electronics type information handling system.

FIG. 6 shows a block diagram a consumer electronics type information handling system architecture environment.

FIG. 7 shows a block diagram of a home multimedia network using a consumer electronics type information handling system architecture.

### DETAILED DESCRIPTION

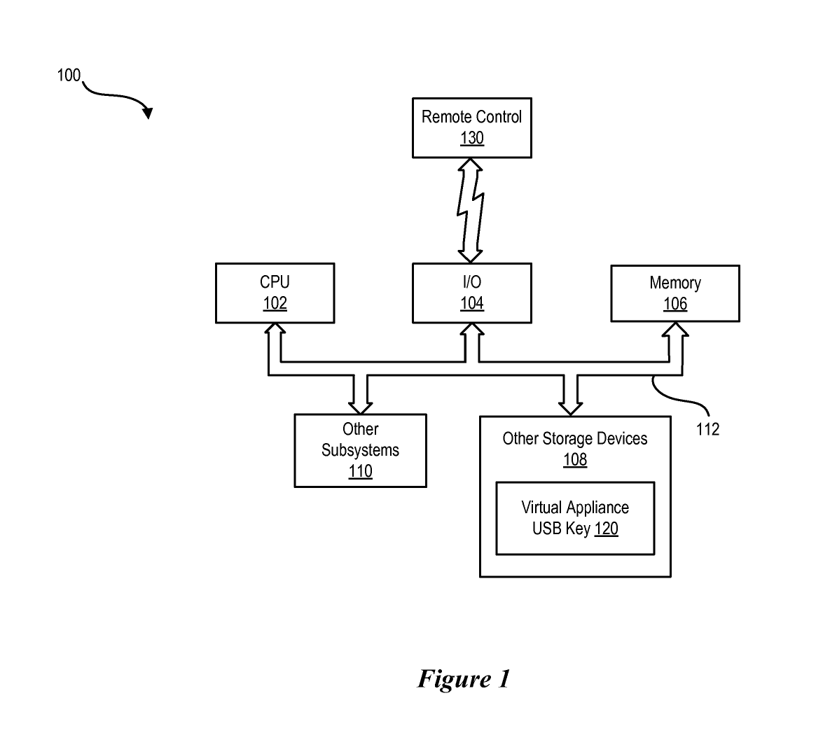

Referring briefly to FIG. 1, a system block diagram of a consumer electronics type information handling system 100 is shown. The information handling system 100 includes a processor 102, input/output (I/O) devices 104, such as a display, a keyboard, a mouse, and associated controllers (each of which may be coupled to remotely to the information handling system 100), a memory 106 including volatile memory such as random access memory (RAM) and non-volatile memory such as a hard disk and drive, and other storage devices 108, such as an optical disk and drive and other memory devices, and various other subsystems 110, all interconnected via one or more buses 112. One example of another storage device 108 is a virtual appliance memory device such as a virtual appliance USB key 120. The I/O devices 104 can also include a remote control 130.

The virtual appliance USB key 120 can include one or a plurality of virtual appliances. Each virtual appliance is a self-contained virtual machine that implements a consumer solution (including an operating system (OS), and application and a default configuration). Examples of self-contained virtual machines can include a productivity module and browser, a media server/content delivery module, a home finance/online banking module, a gaming module, a personal networking module, a home automation and security module, and a home design and maintenance module. Because the virtual machines are self-contained and isolated using virtualization technology, each solution can be preconfigured and ready to use, without a customer having to install and configure the solution. Additionally, the virtual machines provide a stable platform which have no variability when moved from one user or system to another user or system.

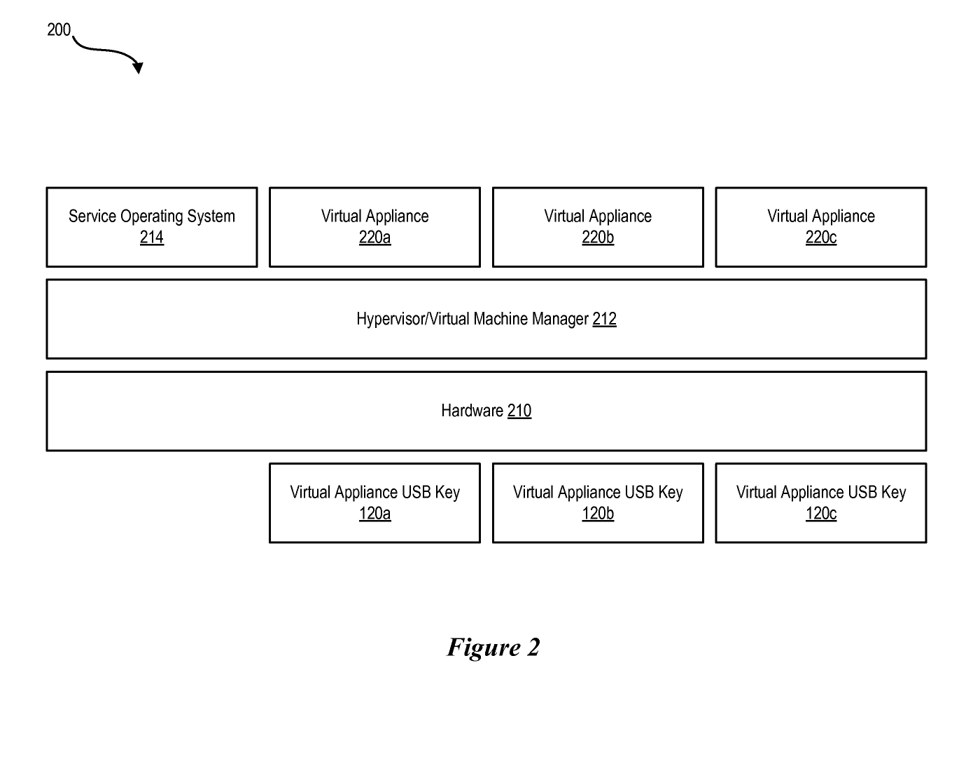

Each of the virtual appliances is installed on the information handling system 100 via a respective virtual appliance USB key 120 (e.g., a personalization pod). Using a virtual appliance USB key 120 not only simplifies an initial installation, but also subsequent need to move the virtual machine if the capacity of the information handling system is exceeded. FIG. 2 shows the architecture diagram of the consumer electronics type information handling system 100.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring to FIG. 2, a system block diagram of a consumer electronics type information handling system infrastructure architecture 200 is shown. More specifically, consumer electronics type information handling system hardware 210 executes a virtual machine manager application 212 (which may be e.g., a hypervisor). The consumer electronics type information handling system infrastructure architecture 200 also includes a service operation system 214 that is executed by the hardware 210.

One or more virtual appliance USB keys 120a, 120b, 120c may be coupled to the hardware 210. Each of the USB keys 120 allow a self contained virtual appliance 220 to be installed on the server 210. In certain embodiments, a digital certificate of authenticity (COA) is included with each virtual appliance 220. The COA is checked by the virtual hardware 210 before the appliance is installed onto the system 200.

A data structure with computing resource requirements is included with each virtual appliance on the USB key. These include CPU requirements, memory requirements, storage requirements, and network bandwidth requirements. Before a virtual appliance is installed, the virtual machine manager 212 ensures that it has enough capacity to host the appliance. The virtual machine manager 212 also contains a resource meter (which may be located on a panel of the information handling system) to represent current resource capacity and remaining resource capacity to simplify capacity planning. The virtual machine manager 212 can also maintain a database of all virtual machines that have been coupled to the device. In this way if a virtual machine is removed and then reinserted, the certification process can be expedited. Additionally, in certain embodiments, the system may have a more limited set of virtual machines to which the system is authorized. In this case, the virtual machine manager 212 can maintain information regarding the more limited set of virtual machines.

Because the personalization pods are self contained and isolated using virtualization technology, each solution can be preconfigured and ready to use, without a customer having to install and configure the solution. The personalization pods are installed onto the hardware via physical memory devices, such as USB keys, which not only simplify the initial installation, but also any subsequent move of the virtual machine such as if the capacity of the hardware is exceeded or if a virtual machine is moved from one device to another.

The virtual machine manager 212 is configured to allow only certified appliances to plug in to the device. Any time a consumer plugs in a non-certified appliance, the virtual machine manager will prompt the user to use a compatible version, or direct the user to a particular website (e.g., a particular universal resource locator (URL)) where the consumer can purchase or certify particular appliances or applications. In certain embodiments, the authentication and certification may be via an asymmetric encryption such s a Deffie-Hellman type encryption, also referred to a asymmetric encryption because it uses two keys instead of a single key. In this case, the public key would be used by the service provider and the secret key would be stored securely on the virtual machine or the virtual machine manager.

In certain embodiment, the hardware can include support for high definition (e.g., Blu-ray type) memory devices. The virtual machine manager 212 can thus enable playback of the high definition memory devices on the system.

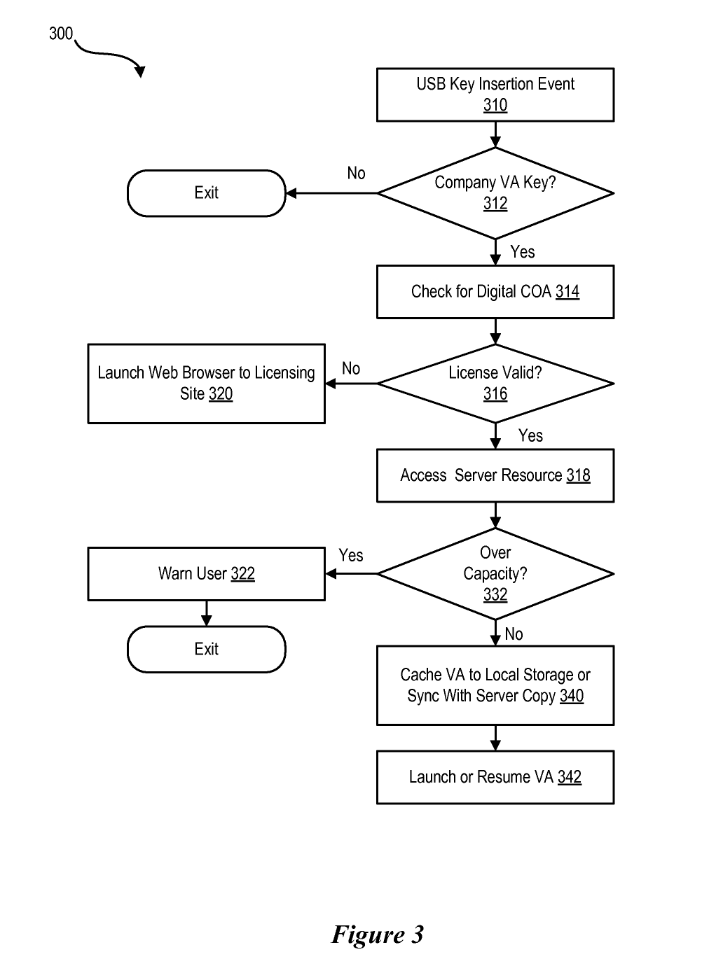

Referring to FIG. 3, a flow chart of the operation of a virtual appliance installation module 300 is shown. More specifically, when the virtual machine manager 212 detects a USB key insertion event at step 310, the virtual machine manager 212 determines whether the USB key is an authorized virtual appliance (VA) key (e.g., does the VA key correspond to a particular application) at step 312. If the key is not an authorized key, then the virtual appliance installation operation exits. If the key is an authorized key, then the virtual machine manager 212 analyzes the digital certificate of authenticity at step 314 and determines whether the virtual appliance includes a valid license at step 316. If the license is not valid, then the virtual appliance installation operation launches a web browser to access a virtual appliance licensing set at step 320.

If the license is valid, then the virtual appliance installation operation accesses the resources of the hardware at step 318. The virtual appliance installation operation then determines whether the hardware 210 is over capacity at step 332 based upon the available resources of the hardware 210 as well as the resources needed by the virtual appliance. If the hardware 210 is over capacity then the virtual appliance installation operation warns the user at step 334. If the resource of the hardware 210 is exceeded (e.g., as determined by step 332), the user is warned by a front panel indicator of this condition. The user may proceed with a number of options. The user can ignore the warning and leave the USB key in the system, in which case the system performance may degrade. Alternately, the user may remove the USB key from the system and insert the key into another system with more system resource capacity.

If the hardware 210 is not over capacity then the virtual appliance installation operation caches the virtual appliance to local storage or synchronizes the virtual appliance with a server copy at step 340. Next, the virtual appliance installation operation launches or resumes operation of the virtual appliance at step 342.

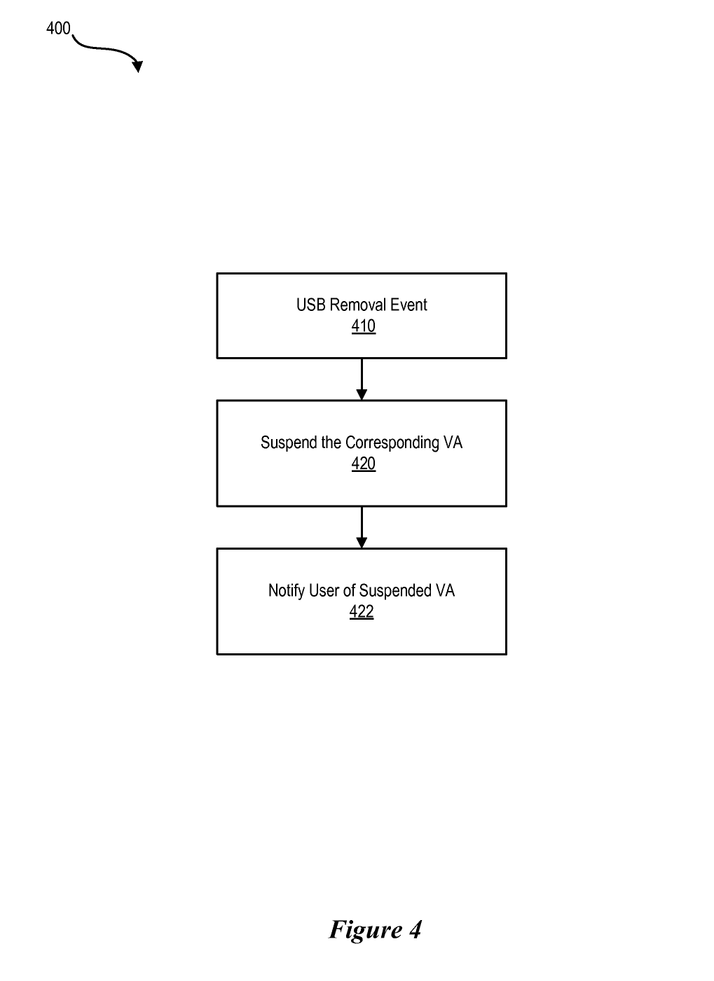

Referring to FIG. 4, a flow chart of the operation of a virtual appliance removal module 400 is shown. More specifically, when the virtual machine manager 212 detects a USB key removal event at step 410, the virtual machine manager 212 suspends execution of the virtual appliance which corresponds to the removed key at step 420 and generates a notification of the suspended virtual appliance at step 422. The front panel of the information handling system 100 also indicates the removal of the key.

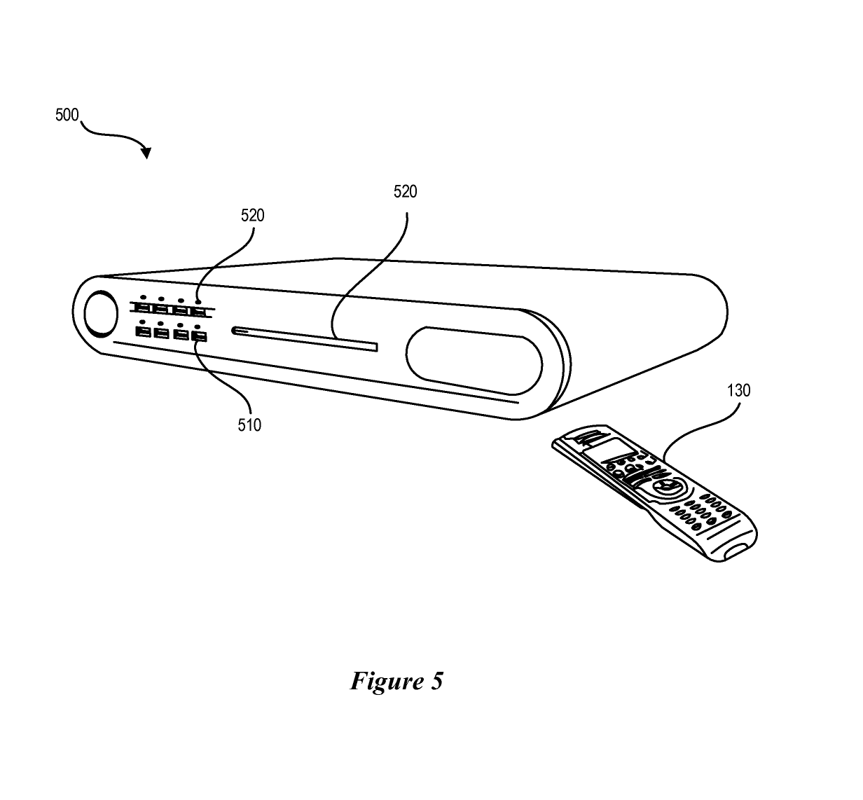

Referring to FIG. 5, a conceptual perspective view of a consumer electronics type information handling system is shown. More specifically, the consumer electronics type information handling system 500 includes a plurality of USB connections 510. Each USB connection includes a corresponding connection indication 520. The USB connection indication 520 can include an indicia (e.g., a color indication) of whether a virtual appliance is installed and executing on the consumer electronics type information handling system 100. The consumer electronics type information handling system 500 also includes a slot 530 into which additional media (such as e.g., a DVD or CD-ROM) may be inserted. The consumer electronics type information handling system 500 also includes a provision for communicating (e.g., an infrared receiver located on the front panel of the system with the remote control device 130 or other types of I/O devices.

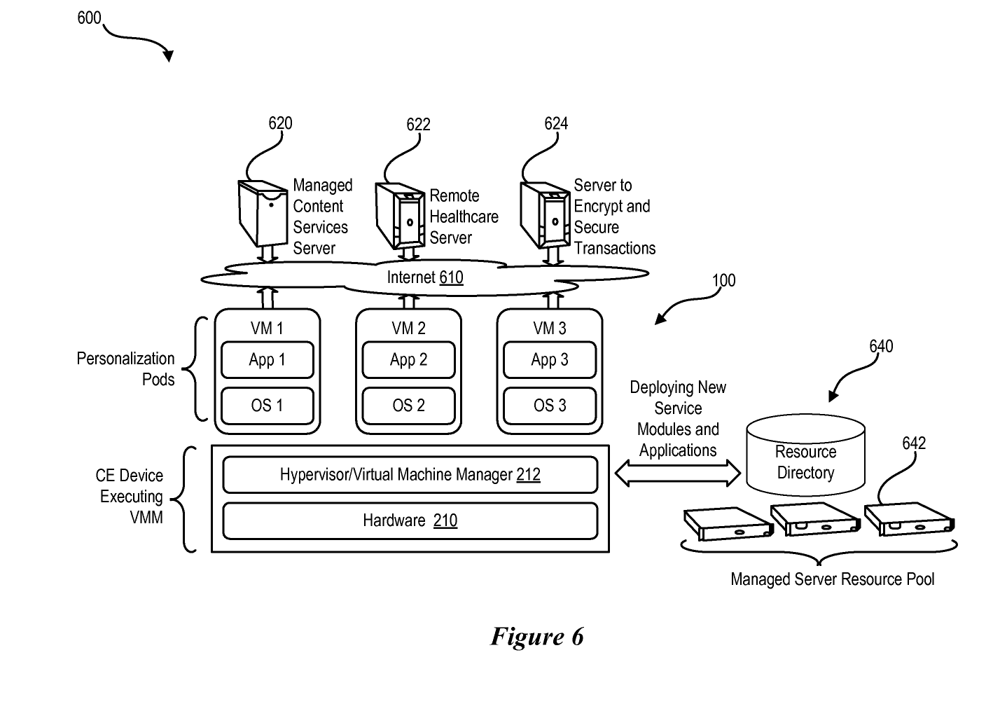

FIG. 6 shows a block diagram a consumer electronics type information handling system architecture environment 600. More specifically, the information handling system 100 includes a plurality of application specific virtual machines (VM1, VM2, and VM3), which are loaded via respective virtual appliance memory devices. Each application specific virtual machine includes a corresponding operating system (OS 1, OS2, and OS3) as well as a corresponding application (App1, App2, and App3). The operating systems and applications execute on the hardware 210 under the control of the virtual machine manager 212. The virtual machines can access the Internet 610, either directly or via the hardware 210 of the system 100.

Each application may be directed to a particular consumer type application. For example, one application (e.g., App1) interacts with a managed content services server 620 via the Internet 610. Examples of manage content services include music types of services (such as download services or satellite radio services), video types of services (such as download services or video access services). Another application (e.g., App2) interacts with a remote healthcare server 622 via the Internet 610. The remote healthcare server enables a user to interact with hospitals or other types of health care services. The virtual machine includes any encryption information or patient information to facilitate the interaction with the healthcare server 622. Another application (e.g., App3) interacts with a banking server 624 via the Internet 610. The banking server enables a user to interact with various banks to perform various online banking transactions. The virtual machine includes any encryption information or customer information to facilitate the interaction with the banking server 622.

The consumer electronics type information handling system architecture environment 600 also includes a resource directory 640 having an associated managed server resource pool 642. The resource directory 640 is accessed by the system 100 when a virtual machine is coupled to the system to validate the virtual machine. The resource directory 640 can also provide service or update information to the system for each certified virtual machine.

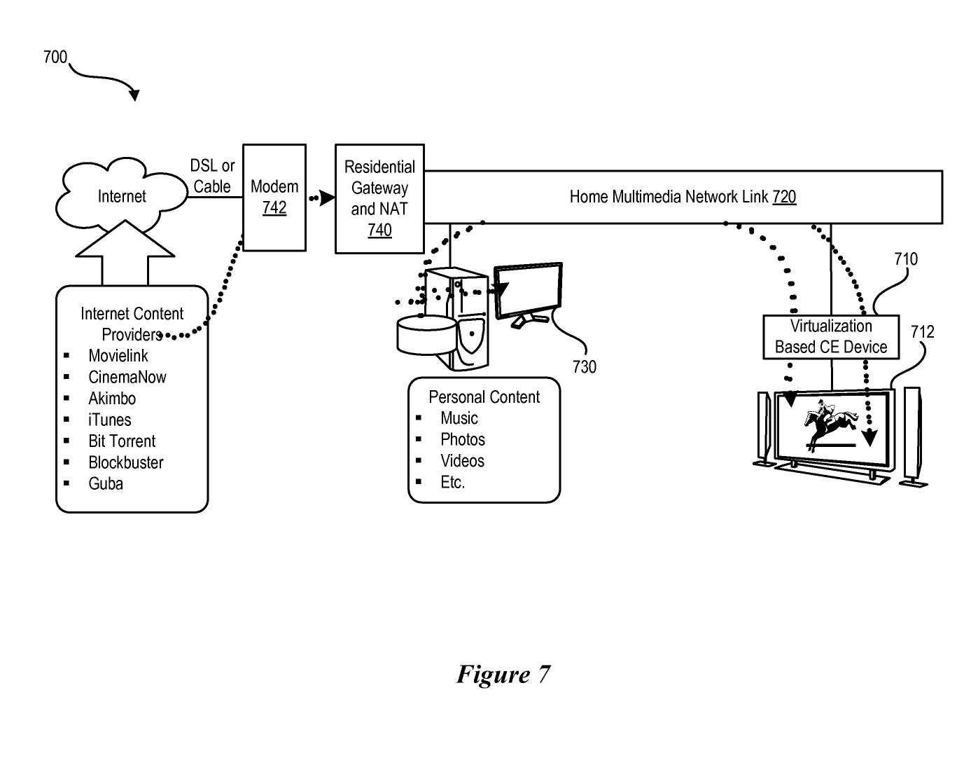

FIG. 7 shows a block diagram of a home multimedia network 700 using a consumer electronics type information handling system architecture. More specifically, a virtualization based consumer electronics device 710 (such as information handling system 100) may be configured as a set top box, which is coupled to audio and video equipment 712. By using the virtualization based consumer electronics device 710, a mode multimedia network 700 can be easily configured. For example, one of the virtual machines coupled to the device could be a network appliance type virtual machine. The virtualization based consumer electronics device 710 is coupled via a home multimedia network line 720 to an information handling system 730 within the home multimedia network 700. The information handling system 730 stores personal content such as personal music, photos and videos which can then be presented on the audio and video equipment 712 via the virtualization based consumer electronics device 710.

Additionally, the virtualization based consumer electronics device 710 may be coupled to the Internet 610 via a residential gateway and network address translation module 740 and modem 742. Access to the Internet allows access to Internet content providers such as the Movielink content provider, the CinemaNow content provider, the Akimbo content provider, the iTunes content provider, the Bit Torrent content provider, the Blockbuster content provider and the Guba content provider.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the virtual appliance memory device 120 may function as a license and resource management token and not necessarily as a storage device for the virtual appliance.

Also for example, the virtual machine manager may include a unique user interface that executes on the hypervisor and display the current services that the customer can access. The user interface can also include notifications and messages to the user for different events and exceptions in a user friendly format.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module. Consequently, the invention is intended to be limited only by the spirit and scope of the appended claims, giving full cognizance to equivalents in all respects.

What is claimed is:

1. A method for delivering pre-packaged software solutions to a consumer electronics type information handling system comprising:
providing a virtual machine (VM) host comprising a plurality of VM resources operable to execute virtual machines;
providing a virtual appliance memory device, the virtual appliance memory device comprising a virtual appliance stored on the virtual appliance memory device, the virtual appliance comprising an application;
installing the virtual appliance onto the virtual machine host via the virtual appliance memory device; and,
hosting the application via the virtual appliance.

2. The method of claim 1 wherein:
the virtual appliance memory device comprises a virtual appliance universal serial bus (USB) key.

3. The method of claim 1 wherein:
the virtual machine host uses embedded virtualization technology to host the application as a virtual appliance.

4. The method of claim 1 wherein:
the application comprises at least one of a productivity and browser application, a media server/content delivery application, a home finance/online banking application, a gaming application, a personal networking application, a home automation and security application, and a home design and maintenance application.

5. The method of claim 1 wherein:
the virtual appliance comprises a digital certificate of authenticity; and further comprising:
checking the validity of the certificate of authenticity the appliance is installed onto the virtual machine host.

6. The method of claim 1 further comprising:
analyzing a resource capacity of the virtual machine host; and,
installing the virtual appliance only when the virtual machine host has enough capacity to host the application.

7. An apparatus for delivering pre-packaged software solutions to a consumer electronics type information handling system comprising:
a virtual machine (VM) host comprising a plurality of VM resources operable to execute virtual machines;
a virtual appliance memory device, the virtual appliance memory device comprising a virtual appliance stored on the virtual appliance memory device, the virtual appliance comprising an application;
means for installing the virtual appliance onto the virtual machine host via the virtual appliance memory device; and,
means for hosting the application via the virtual appliance.

8. The apparatus of claim 7 wherein:
the virtual appliance memory device comprises a virtual appliance universal serial bus (USB) key.

9. The apparatus of claim 7 wherein:
the virtual machine host uses embedded virtualization technology to host the application as a virtual appliance.

10. The apparatus of claim 7 wherein:
the application comprises at least one of a productivity and browser application, a media server/content delivery application, a home finance/online banking application, a gaming application, a personal networking application, a home automation and security application, and a home design and maintenance application.

11. The apparatus of claim 7 wherein:
the virtual appliance comprises a digital certificate of authenticity; and further comprising:
means for checking the validity of the certificate of authenticity the appliance is installed onto the virtual machine host.

12. The apparatus of claim 7 further comprising:
means for analyzing a resource capacity of the virtual machine host; and,
means for installing the virtual appliance only when the virtual machine host has enough capacity to host the application.

13. A consumer electronics type information handling system comprising:
a virtual appliance memory device for delivering pre-packaged software solutions to the information handling system, the virtual appliance memory device comprising a virtual appliance stored on the virtual appliance memory device, the virtual appliance comprising an application;
a virtual machine (VM) host comprising a plurality of VM resources operable to execute virtual machines, the virtual machine host installing the virtual appliance onto the virtual machine host via the virtual appliance memory device and hosting the application via the virtual appliance.

14. The information handling system of claim 13 wherein:
the virtual appliance memory device comprises a virtual appliance universal serial bus (USB) key.

15. The information handling system of claim 13 wherein:
the virtual machine host uses embedded virtualization technology to host the application as a virtual appliance.

16. The information handling system of claim 13 wherein:
the application comprises at least one of a productivity and browser application, a media server/content delivery application, a home finance/online banking application, a gaming application, a personal networking application, a home automation and security application, and a home design and maintenance application.

17. The information handling system of claim 13 wherein:
the virtual appliance comprises a digital certificate of authenticity; and
the virtual machine host checks the validity of the certificate of authenticity the appliance is installed onto the virtual machine host.

18. The information handling system of claim 13 wherein the virtual machine host:
analyzes a resource capacity of the virtual machine host; and,
installs the virtual appliance only when the virtual machine host has enough capacity to host the application.
